(19) United States
(12) Patent Application Publication
(10) Pub. No.: US 2003/0020652 A1
(43) Pub. Date: Jan. 30, 2003

(54) Apparatus for tracking moving satellites

(76) Inventors: Ali Louzir, Rennes (FR); Henri Fourdeux, Corps-Nuds (FR)

Correspondence Address: Joseph S Tripoli, Thomson Multimedia Licensing Inc, PO Box 5312, Princeton, NJ, 08540, US

(21) Appl. No.: 09/673,894

(22) PCT Filed: Apr. 15, 1999
(86) PCT No.: PCT/FR99/00881

(30) Foreign Application Priority Data
Apr. 23, 1998 (FR) 9805112

(51) Int. Cl. H01Q 3/02; G01S 5/04

(52) U.S. Cl. 342/432; 342/374

(57) ABSTRACT

The invention relates to an apparatus for tracking nonsynchronous satellites.

It is characterized in that the said apparatus includes at least one set of independent transmitter and/or receiver primary sources (6) arranged in the vicinity of the focusing surface (5) of the apparatus. The said primary sources (6) are coupled to switching means (21, 23, 30, 32, 40, 41, 42, 43) which operationally allow the selection of a first source associated with a focal point corresponding to a first satellite and a second source associated with a second focal point corresponding to a second satellite.

Particular application to the field of the tracking of nonsynchronous satellites.

The present invention relates to an apparatus for transmitting and/or receiving signals in a communication system employing nonsynchronous satellites.

Hitherto, commercial telecommunications via satellite have been achieved almost entirely via geostationary satellites, which are especially beneficial by virtue of their unchanging relative positions in the sky. However, the geostationary satellite exhibits major drawbacks such as considerable attenuations of the signals transmitted related to the distance separating the user antennas from the geostationary satellite (of the order of 36,000 kilometers, the corresponding losses then rising to around 205 dB in the Ku band) and transmission lags (typically of the order of 250 ms to 280 ms) thus becoming clearly perceivable and perturbing especially for real-time applications such as telephony, video conferencing, etc. Furthermore, the geostationary orbit, situated in the equatorial plane, poses a visibility problem In respect of the regions at high latitudes, the angles of elevation becoming very small for the regions close to the poles.

The alternatives to employing geostationary satellites are:

the use of satellites in inclined elliptical orbits, the satellite then being almost stationary above the region situated at the latitude of its apogee for a duration of possibly up to several hours,

the implementation of constellations of satellites in circular orbits, in particular in low orbit (“Low Earth Orbit” or LEO) or in mid-orbit (“Mid Earth Orbit” or MEO), the satellites of the constellation flying past in turn within visibility of the user terminal for a duration of from some ten minutes to around one hour.

In both cases, service cannot be provided permanently by a single satellite, continuity of service demanding that several satellites fly over the service area one after another.

The aim of the invention is therefore to produce an antennas apparatus for tracking nonsynchronous satellites flying along predefined trajectories, making it possible to pick up at least two satellites following one another within the area of visibility of the apparatus.

To this end, the subject of the invention is an apparatus for transmitting and/or receiving signals in a communication system employing nonsynchronous satellites, comprising pluridirectional focusing means possessing a focusing surface comprising a plurality of focal points, characterized in that it includes:

a continuous string of independent transmitter and/or receiver radiating elements or group of radiating elements, the said radiating elements being arranged in the vicinity of focal points of the said focusing surface,

electronic switching means coupled to the radiating elements, for operationally switching at least one first element associated with a first focal point and a second element associated with a second focal point to circuits for processing the signals transmitted and/or received, the said focal points corresponding to the respective positions of a first and a second satellite at a given instant,

means of monitoring the switching means for determining the said at least first and second elements corresponding to the respective positions of the first and second satellites at the said given instant.

The term “active” will be ascribed to any element which exchanges a major part of the useful data with a likewise so-called “active” satellite, whilst the term “passive” will designate any other element which exchanges signalling data and little useful data with another so-called “passive” satellite.

In this way, the apparatus according to the invention makes it possible to transmit and/or receive at least two beams focused at different places and to not suffer from a switching lag when switching from a first satellite to another.

According to one embodiment, the switching means comprise switching units comprising first switches with one input linked to the circuit for processing the transmission signals and with N×M outputs linked to the N×M radiating elements and/or second switches with N×M inputs linked to the N×M radiating elements and with an output linked to the circuit for processing the reception signals in respect of the reception signals, the string of radiating elements exhibiting the form of a matrix of elements with N rows and M columns.

According to one embodiment, the integer N is predetermined in such a way that the apparatus exhibits, when tracking satellites, a radiation pattern which can be inclined from 10° to 90° in elevation.

The integer N is predetermined in such a way as to allow azimuthal visibility about a preset azimuth value. The elevation will be understood within the present patent application as the angle existing between the horizontal plane and the radius R passing through the centre of the apparatus and the satellite in the instantaneous plane of the trajectory. The azimuth is also defined as the angle between the said radius R and the vertical in the plane transverse to the instantaneous plane of the trajectory.

In the particular case where the trajectories of the nonsynchronous satellites are stationary or remain close to one another, the integer M is chosen in such a way as to ensure their tracking by azimuthal adjustment of the beam about a preset azimuth value.

There will be advantage in incrementing M respectively N by one unit for a variation in gain of ±0.5 dB in azimuth respectively in elevation about a given direction of radiation corresponding to the maximum level.

According to one embodiment, the string of radiating elements, the switching means and the circuits for processing the transmission and/or reception signals are arranged on one and the same layer of a substrate.

The string of radiating elements is etched on a first layer of a substrate, under which layer is disposed a second layer including the said switches and the circuits for processing the transmission and/or reception signals.

The string of radiating elements is etched on a first layer under which are arranged a second and third layer respectively including the said switching means and the circuits for processing the transmission and/or reception signals.

First excitation lines for exciting the elements are etched on the second layer for the transmission and/or the reception of a first beam and second excitation lines are etched on the third layer for the transmission and/or the reception of a second beam.

Advantageously, slots are etched on the lower surface of the first layer forming an earth plane, so as to allow the exchanging of energy with the lower layers.

To allow tracking of the first satellite when its trajectory drifts azimuthally whilst the second satellite is expected on its nominal trajectory, the apparatus includes first and second independent means of support adjacent to the focusing surface and on which are arranged the continuous string of radiating elements. Thus, the latter solution is advantageous especially in the case where the nonsynchronous satellites may have considerable azimuthal variations. In particular, it makes it possible to reduce the value of the integer M to 1, this corresponding to electronic elevational tracking, whilst ensuring azimuthal tracking mechanically.

Advantageously, the said first and second support means are coupled to actuation means including means of rotation of the first and second means of support for orienting the latter in such a way as to allow azimuthal tracking of satellites. [lacuna] of the said means of support in the course of the tracking of the targets and/or sources by the said apparatus.

Preferably, these means of rotation have an axis of rotation passing through the centre of the Luneberg lens about which the said first and second support means are able to revolve.

According to one embodiment, the apparatus includes monitoring means for control of the motors of the elements and of the actuation means.

According to one embodiment, the focuser element of the apparatus is a spherical Luneberg lens.

Preferably, the apparatus is intended for the tracking of nonsynchronous satellites.

There may be advantage in the apparatus furthermore including transmission and/or reception means located in the vicinity of a point on the focusing surface of the apparatus and able to communicate permanently with at least one geostationary satellite. Preferably, this third element is fixed.

Other characteristics and advantages of the present invention will emerge from the description of the exemplary embodiment which follows, taken by way of nonlimiting example, with reference to the appended figures in which:

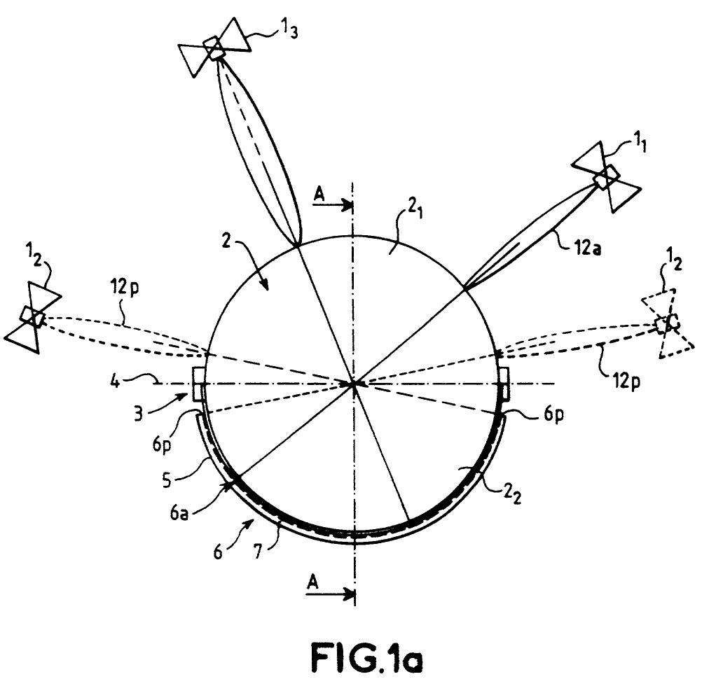

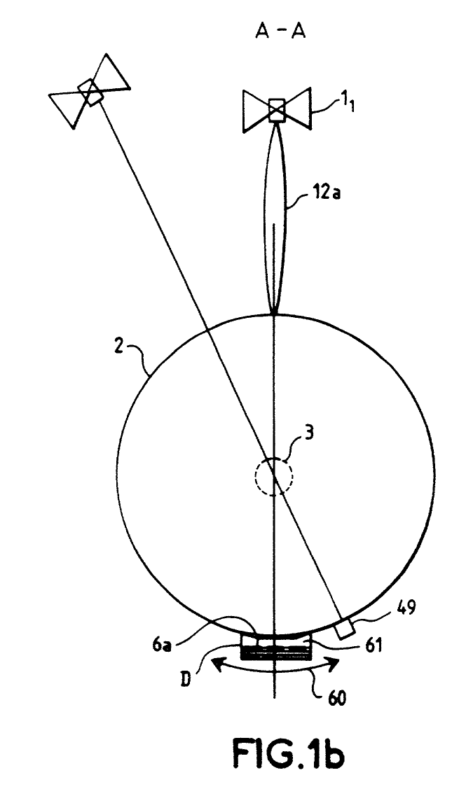

FIG. 1.a represents a diagram of a vertical section through an embodiment of the tracking apparatus according to the invention,

FIG. 1.b represents a diagrammatic view of the apparatus according to the invention represented in FIG. 1.a, along the section A-A,

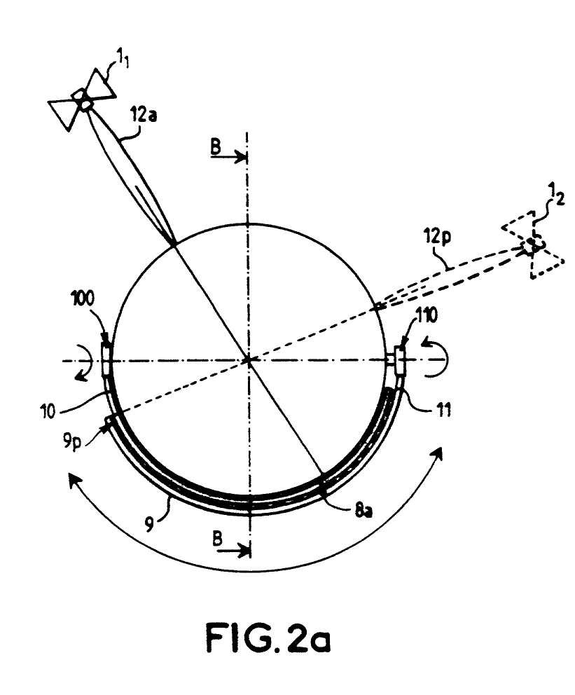

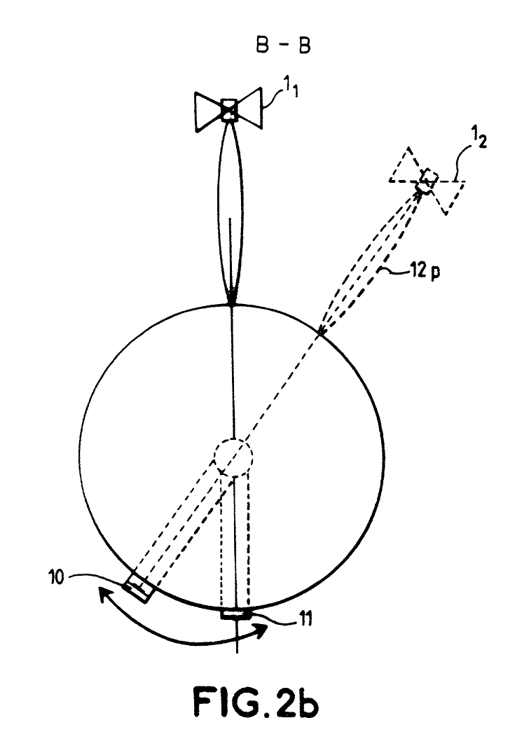

FIG. 2.a represents a diagram of a variant of the tracking apparatus of FIGS. 1.a and 1.b,

FIG. 2.b represents a view of the apparatus according to the invention represented in FIG. 2.a along the section B-B,

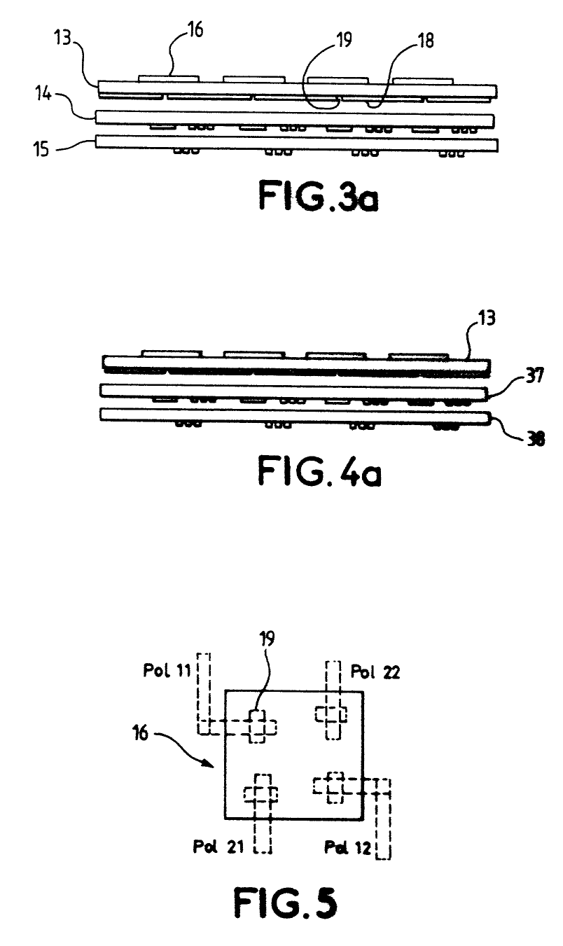

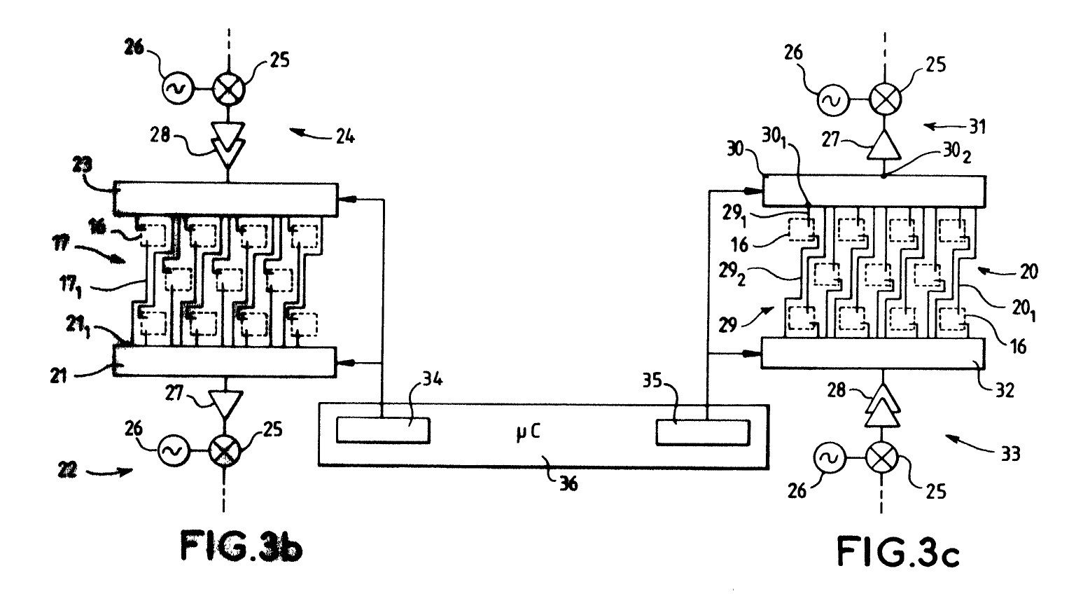

FIG. 3.a is a detailed view of the area D illustrated in FIG. 1.b, and represents a vertical section through a first layer of patches facing the radiation space, a second layer of circuits for feeding the said patches able to transmit a first beam, and a third layer of circuits for feeding the said patches 16 able to transmit a second beam,

FIG. 3.b represents the various circuits comprising the second layer of FIG. 3.a,

FIG. 3.c represents the various circuits comprising the third layer of FIG. 3.a,

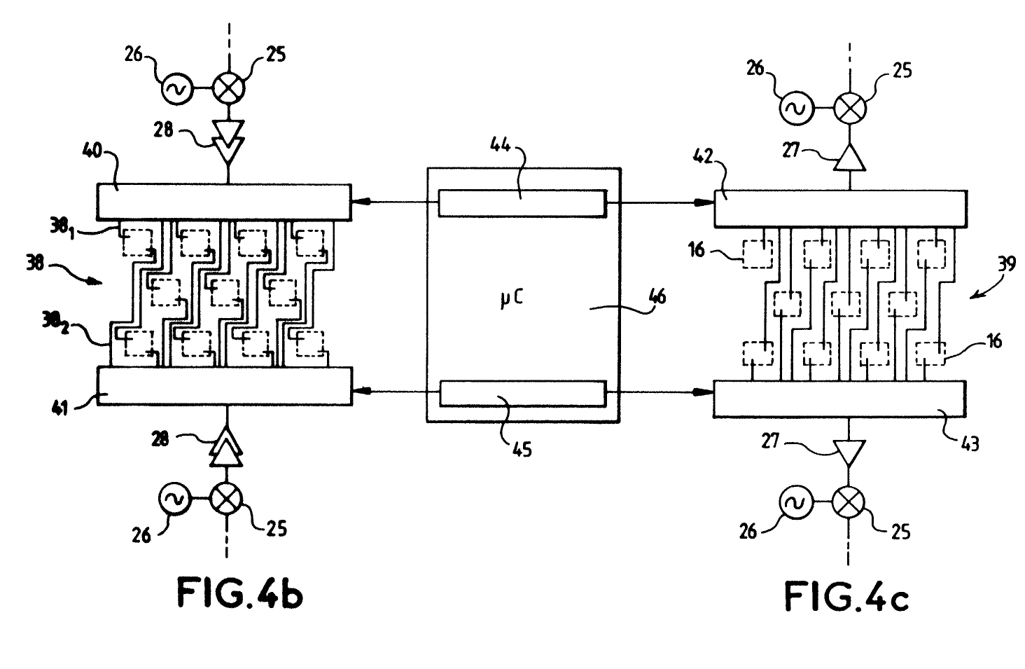

FIG. 4.a is a detailed view of a variant of the area D of FIG. 1.a, and represents the first layer of radiating elements oriented towards the radiation space, a second layer for processing the signals to be transmitted and a third layer for processing the signals received,

FIG. 4.b represents the second layer for processing the signals to be transmitted of FIG. 4.a,

FIG. 4.c represents the third layer for processing the signals received of FIG. 4.a,

FIG. 5 represents the slots on the face opposite the face which includes the radiating elements of the first layer.

To simplify the description, the same references will be used in the latter figures to designate the elements which fulfil identical functions.

According to the embodiment described in FIGS. 1.a and 1.b, the tracking apparatus includes a solid spherical Luneberg lens 2 of a dielectric material with characteristics known per se. On the two ends of a diameter 4 it possesses two adjusting buttons 3. The plane transverse to the section of FIG. 1.a passing through the diameter 4 delimits the said lens 2 as two hemispheres 2₁ and 2₂, the hemisphere 2₁ facing the radiation space where the satellites 1₁ and 1₂ are located, whilst the hemisphere 2₂ has its focusing surface 5 facing a set of radiating elements 6. This set 6 is supported by an electrically transparent cap 61 (made of polystyrene foam) hugging the shape of the hemisphere 2₂, thus playing the role of interface between the latter and the set 6. The set 6 and the cap 61 have the shape of a semi-arch of rectangular cross section. The radiating elements 6 consist of patches 7, whose disposition will be explained later. The satellite 1₁ is within visibility of the active patch 6ₐ, whilst the satellite 1₂ is within visibility of the patch 6ₚ, standing by for active tracking. In the section of FIG. 1.b, it should be noted that the patch 6ₐ makes it possible to sight the satellite 1₁. The adjusting buttons 3 allow adjustment of the sighting of the apparatus azimuthally upon installation, as illustrated by the double arrow 60. The apparatus is linked to a unit inside the dwelling on which the apparatus rests, this unit being a television decoder (not represented).

The apparatus furthermore includes a transmitter/receiver element 49 making it possible to communicate with a geostationary satellite 1₃. Advantageously, the transmitter/receiver element 49 is an antenna which includes radiating patches. According to a variant, the element 49 is a waveguide antenna.

FIG. 2.a represents a double layer of primary sources 8 and 9, on independent supports 10 and 11 respectively. Since the azimuthal mechanical adjustment of the two supports 10 and 11 is independent, the active primary source 8ₐ can continue to sight the satellite 1₁ whilst the source 9ₚ is standing by to track the satellite 1₂ actively. This does not exclude the fact that the source 9ₚ tracks the satellite 1₂ but the frequency band allocated to it for exchanging information with the satellite 1₂ is then reduced relative to the frequency band which is allocated to the exchanging of information between the satellite 1₁ and the active primary source 8ₐ. This will be explained more clearly hereinbelow.

To the active sources 6ₐ, 8ₐ, there corresponds a so-called active beam 12ₐ, whilst to the passive sources 6ₚ, 9ₚ there corresponds a so-called passive beam 12ₚ. The control of the supports 10, 11 is carried out respectively by motors 100, 110 whose actuation is itself controlled by monitoring means 36, 46 detailed hereinafter.

FIG. 3.a is a detailed view of the area D illustrated in FIG. 1.a and represents a vertical section through a first layer 13 of patches 16 facing the radiation space, a second layer 14 of circuits for feeding the said patches 16 able to transmit/receive a first beam, and a third layer 15 of circuits for feeding the said patches 16 able to transmit/receive a second beam. FIG. 3.b represents the feed circuit for the patches 16, which is disposed on the second layer of FIG. 3.a and is able to excite the first beam, whilst FIG. 3.c illustrates characteristics identical to FIG. 3.b for the excitation of the second beam. The term “beam” is used in the present patent application to designate any exchange between a patch 16 and a satellite, whether in transmission or in reception.

The upper surface of the first layer 13 exhibits the patches 16 disposed in such a way as to form an array of N rows and M columns, here N being equal to 4 and M=3 to simplify the description. It will be noted that these values have been taken by way of example and that N can be of the order of 50 for elevational coverage of from 10° to 90°. The lower surface of the layer 13 exhibits a metallized surface 18 forming an earth plane common to the three layers of circuits. Slots 19 detailed in FIG. 5 are etched in the earth plane 18, allowing radiation of the waves between the patches 16 and the second and third layers 14, 15. The lower surface of the second layer 14 exhibits the feed circuit 17 for the patch 16 (active or passive) able to transmit/pick up the first beam (active or passive) whilst the third layer 15 comprises the feed circuit 20 for the patch 16 (respectively passive or active) able to transmit/pick up the second beam (respectively passive or active).

In FIG. 3.b, feed lines excite the patches 16 on orthogonal sides. First lines 17₁ convey the signals received by the patches 16 and drive ports 21₁ of a switch 21, an output 21₂ of which drives a frequency conversion circuit 22 for transmitting the signals thus transposed into Satellite Intermediate Band (or SIB) to a unit inside a dwelling (not represented). It should be noted that this SIB band is standardized within the framework of a live television satellite communication apparatus. Within the present framework, it is not obligatory to take this same band for the transposition into intermediate frequency.

Second lines 17₂ originate from a second switch 23 and convey the signals to be transmitted to the satellite. The second switch 23 selects the patch 16 for sighting the satellite. The input of the switch 23 is linked to a frequency conversion circuit 24 whose input is linked to the unit inside the dwelling.

Each frequency conversion circuit 22, 24 as well as those mentioned subsequently comprise in a manner known per se a mixer 25 and a local oscillator 26 for the frequency transposition. In a down pathway, the frequency conversion circuits furthermore comprise a low-noise amplifier 27, whilst in an up pathway, the frequency conversion circuits comprise a power amplifier 28.

In FIG. 3.c, feed lines excite the patches 16 on orthogonal sides. Third lines 29₁ convey the signals received by the patches 16 and drive ports 30₁ of a third switch 30, an output 30₂ of which drives a frequency conversion circuit 31 for transmitting the signals thus transposed into Satellite Intermediate Band to the inside unit. Fourth lines 29₂ originate from a fourth switch 32 and convey the signals to be transmitted to the satellite. The fourth switch 32 selects the patch 16 for sighting the satellite. The input of the switch 32 is linked to a frequency conversion circuit 33 whose input is linked to the inside unit.

It should be stressed furthermore that the switches 21, 23 are controlled by first monitoring means 34 making it possible to select the patch 16 able to sight the first satellite whereas the switches 30, 32 are controlled by second monitoring means 35 making it possible to select the patch 16 able to sight the second satellite. For example, in the present embodiment, the first and second control means are included in the microcontroller 36 containing, stored in a memory 37, information such as the history of the trajectory of the satellites, etc. and also a gain value playing the role of threshold for the detection of a satellite below which the microcontroller 36 must switch either to the adjacent patch 16 so as to track the satellite or to the patch 16 sighting the second satellite with the second beam. The switches 21, 23, 30 and 32 are for example electronic chips having k control tags linked to the microcontroller 36 and having N×M tags linked to the various patches 16 and an input or output tag.

FIG. 4.a is a detailed view of a variant of the area D of FIG. 1.a, and represents the first layer 13 of patches 16 oriented towards the radiation space, a second layer 37 for processing the signals to be transmitted and a third layer 38 for processing the signals received. FIG. 4.b represents the second layer 37 for processing the signals to be transmitted of FIG. 4.a, whilst FIG. 4.c represents the third layer 38 for processing the signals received of FIG. 4.a.

The lower surface of the second layer 37 exhibits a feed circuit 38 for the patch 16 able to transmit the first and second beams whilst the third layer 38 comprises the feed circuit 39 for the patch 16 able to receive the first and second beams.

It should be observed here that in FIGS. 3.a to 3.c the reception and transmission pathway is produced according to two orthogonal polarizations. This is obviously not obligatory but allows better isolation between the transmission and reception pathways. The transmission/reception of the first beam is carried out along two orthogonal polarizations on the layer 14 and the transmission/reception of the second beam is carried out along two orthogonal polarizations on the layer 15.

On the other hand, the patch 16 is excited via two opposite sides so as to transmit the first beam and the second beam separately on the layer 37, and to pick up the first beam and the second beam separately on the layer 38.

Additionally, the structure which includes a single patch 16 on the first substrate layer 13 can be replaced with a structure which includes two patches separated from a substrate layer, facing one another and resonating at substantially shifted frequencies so as to broaden the frequency passband.

In FIG. 4.b, feed lines 38 excite the patches 16 on opposite sides. First lines 38₁ convey the signals to be transmitted on a first beam according to one polarization and second lines 38₂ convey signals to be transmitted on a second beam according to the same polarization. These lines 38₁, 38₂ are linked respectively to first and second switches 40, 41. An input of each of the switches 40, 41 is linked to a frequency converter circuit of the type explained earlier.

In the same way, represented in FIG. 4.c are feed lines 39 exciting the patches 16 on opposite sides. First lines 39₁ convey the signals received on a first beam according to one polarization and second lines 39₂ convey signals received on a second beam according to the same polarization. These lines 39₁, 39₂ are linked respectively to first and second switches 42, 43. An output of each of the switches 42, 43 is linked to a frequency converter circuit of the type explained earlier.

The switch 40 is controlled by third monitoring means 44 included in a microcontroller 46 making it possible to select the patch 16 able to obtain the optimal beam for transmission to the first satellite, whilst the switch 41 is controlled by fourth monitoring means 45 able to obtain the optimal beam for transmission to the second satellite. Likewise, the switch 42 is controlled by the third monitoring means 44 making it possible to select the patch 16 able to obtain the optimal beam for reception of the signals from the first satellite, whilst the switch 43 is controlled by the fourth monitoring means 45 able to obtain the optimal beam for reception of the signals from the second satellite.

FIG. 5 represents the slots 19 on the face opposite the face which includes the patches 16 of the first layer 13. Lines Pol11 and Pol21 exciting the patch 16 via orthogonal sides correspond to the excitation lines feeding the slots 19₃ in the case of the embodiment of FIGS. 3.a to 3.c. In this case, one and the same patch 16 conveys the data transmitted and received by a beam. Excitation via the two orthogonal sides allows separation of the reception pathway and of the transmission pathway on two orthogonal polarizations. The notation Polij corresponds to beam line j conveyed according to polarization i.

The lines Pol11 and Pol12 correspond to the variant of FIGS. 4.a to 4.c. Lines Pol11 and Pol12 excite the patch 16 via opposite sides and convey the data of the reception pathway of the first beam on one line and of the second beam on a second line (or the data of the transmission pathway of the first beam on one line and of the second beam on a second line).

The apparatus according to the invention operates in the following manner:

The first satellite is firstly located within the field of visibility of the apparatus. The active beam associated with the active patch follows it over its trajectory. Before the first satellite disappears from the field of visibility of the apparatus, a second satellite appears. The apparatus continues to communicate, in transmission/reception, useful data of the first satellite whilst tracking the second satellite and whilst communicating only the data signalling the latter satellite to the monitoring means. The Luneberg lens has for example a diameter of 35 cm, and the apparatus operates at frequencies of the order of 12 GHz. The switchover from one patch to another occurs when the variations in transmission/reception gain exceed ±0.5 dB, or 1 dB relative to the radiation equivalent to the maximum level. The integer N will be determined as a function of the azimuthal coverage required, taking into account the rule, by way of example, of an incrementation of N by one unit for an extra azimuthal coverage of 3°, for the example above. The choices of M and N obviously depend among other things on the width of the beams, on the gain fluctuations which the apparatus can tolerate and on the dimensions of the patches 16 which limit the minimum gaps between them.

The monitoring means measure the level of the signal received/transmitted to the satellite (active or passive). As soon as the latter is below a predetermined threshold, they actuate the appropriate switches with a view to switching to another patch and to determining the patch which allows the best tracking of the satellite.

Of course, the invention is not limited to the embodiments as described. Thus, the Luneberg lens can be cylindrical.

Lastly, the management of the switching from the satellite 1₁ to the satellite 1₂ can be carried out in any manner other than that contemplated for explaining the operation of the present invention. It can include all known methods of multiple access to the said at least two satellites 1₁, 1₂.

1. Apparatus for transmitting and/or receiving signals in a communication system employing nonsynchronous satellites, comprising pluridirectional focusing means (2) possessing a focusing surface (5) comprising a plurality of focal points, characterized in that it includes:
a continuous string of independent transmitter and/or receiver radiating elements or group of radiating elements (6), the said radiating elements (6) being arranged in the vicinity of focal points of the said focusing surface (5),
electronic switching means (21, 23, 30, 32, 40, 41, 42, 43) coupled to the radiating elements (6), for operationally switching at least one first element (6ₐ) associated with a first focal point and a second element (6ₚ) associated with a second focal point to circuits for processing the signals transmitted and/or received (22, 24, 31, 33), the said focal points corresponding to the respective positions of a first (1₁) and a second (1₂) satellite at a given instant,
means of monitoring (36, 46) the switching means (21, 23, 30, 32, 40, 41, 42, 43) for determining the said at least first (6ₐ) and second (6ₚ) elements corresponding to the respective positions of the first (1₁) and second (1₂) satellites at the said given instant.

2. Apparatus according to claim 1, characterized in that the monitoring means (36, 46) comprise first and second (34, 35), or third and fourth (44, 45) monitoring means for the determination of the radiating element (6ₐ) with which the exchanges of useful data are to be performed.

3. Apparatus according to either of claims 1 and 2, characterized in that the focuser element of the apparatus is a spherical Luneberg lens (2).

4. Apparatus according to one of claims 1 to 3, characterized in that the apparatus includes first (10) and second (11) independent means of support adjacent to the focusing surface (5) and on which are arranged the string of radiating elements (6).

5. Apparatus according to claim 4, characterized in that the said first (10) and second (11) support means are coupled to actuation means (3) including means of rotation (100, 110) of the first (10) and second (11) means of support for orienting the latter in such a way as to allow azimuthal tracking of satellites (1₁, 1₂).

6. Apparatus according to claim 5, characterized in that these means of rotation (100, 110) have an axis of rotation (4) passing through the centre of the Luneberg lens (2) about which the said first and second support means (10, 11) are able to revolve.

7. Apparatus according to one of claims 1 to 6, characterized in that the switching means comprise switching units comprising first switches (23, 32, 40, 41) with one input linked to the circuit for processing the transmission signals and with N×M outputs linked to the N×M radiating elements and/or second switches (21, 30, 42, 43) with N×M inputs linked to the N×M radiating elements and with an output linked to the circuit for processing the reception signals in respect of the reception signals, the string of radiating elements exhibiting the form of a matrix of elements with N rows and M columns.

8. Apparatus according to claim 7, characterized in that the integer N is predetermined in such a way that the apparatus exhibits, when tracking satellites, a radiation pattern which can be inclined from 10° to 90° in elevation.

9. Apparatus according to one of claims 1 to 8, characterized in that the string of radiating elements (6), the switching means (21, 23, 30, 32, 40, 41, 42, 43) and the circuits (25, 26, 28) for processing the transmission and/or reception signals are arranged on one and the same layer (13) of a substrate.

10. Apparatus according to one of claims 1 to 8, characterized in that the string of radiating elements (6) is etched on a first layer (13) of a substrate, under which layer is disposed a second layer including the said switches and the circuits for processing the transmission and/or reception signals.

11. Apparatus according to one of claims 1 to 8, characterized in that the string of radiating elements (6) is etched on a first layer (13) under which are arranged a second (14, 37) and third (15, 38) layer respectively including the said switching means (21, 23, 30, 32, 40, 41, 42, 43) and the circuits (25, 26, 28) for processing the transmission and/or reception signals.

12. Apparatus according to claim 10 or 11, characterized in that first excitation lines for exciting the elements (6) are etched on the second layer (14) for the transmission and/or the reception of a first beam and second excitation lines are etched on the third layer (15) for the transmission and/or the reception of a second beam.

13. Apparatus according to one of claims 1 to 12, characterized in that the apparatus furthermore includes transmission and/or reception means (49) located in the vicinity of a point on the focusing surface (5) of the apparatus for communication with at least one geostationary satellite (1₃).
